(19) United States
(12) Patent Application Publication
(10) Pub. No.: US 2023/0419223 A1
(43) Pub. Date: Dec. 28, 2023

(54) VENDOR RISK ASSESSMENT

(71) Applicant: Venseca, Inc., Breinigsville, PA (US)

(72) Inventor: Lance Mueller, Breinigsville, PA (US)

(21) Appl. No.: 18/343,655

(22) Filed: Jun. 28, 2023

Related U.S. Application Data
(60) Provisional application No. 63/367,186, filed on Jun. 28, 2022.

(51) Int. Cl. G06Q 10/0635

(52) U.S. Cl. CPC G06Q 10/0635

(57) ABSTRACT

Embodiments of the invention provide organizations with an efficient method to evaluate the inherent cybersecurity risk to make informed decisions about partnering, acquiring, or doing business with other organizations.

### CROSS-REFERENCE TO RELATED APPLICATIONS

This application claims priority to U.S. provisional patent application Ser. 63/367,186, filed Jun. 28, 2022, which application is incorporated herein in its entirety by this reference thereto.

### FIELD

Various of the disclosed embodiments concern vendor security risk assessment.

### BACKGROUND

Vendor security risk assessments provide visibility to an organization's cybersecurity.

Security risk assessments are particularly important when a vendor processes critical business functions on behalf of the organization, accesses sensitive customer/employee data, stores/maintains organizations intellectual property, and interacts with customers of the organization.

Organizations should perform security risk assessment activities as part of the organization's standard procurement processes during key stage gate milestones, e.g. evaluation, selection, onboarding, etc. Vendors should be risk ranked and those ranked as high risk should be re-assessed at least annually to ensure the vendor still meets the organization's risk tolerance and that the vendor's scope has not changed since onboarding to ensure new risks have not been introduced to the organization.

Third party risk management (TPRM) functions within an organization may not exist, may be under resourced, or lack experience, all of which can dilute the overall qualitative and quantitative effectiveness of security risk assessments. Because many organizations now rely on third parties to perform some operational element of their business systems, insurance companies now review and include TPRM programs in their evaluation to provide cybersecurity liability insurance coverage. Premiums for such coverage are skyrocketing and in some scenarios organizations are deemed uninsurable if they lack the proper security controls.

### SUMMARY

Embodiments of the invention provide organizations with an efficient method to evaluate the inherent cybersecurity risk to make informed decisions about partnering, acquiring, or doing business with other organizations.

### BRIEF DESCRIPTION OF THE DRAWINGS

FIG. 1 shows a vendor security risk assessment system according to the invention;

FIG. 2 shows the creation of a digital trust score in a vendor security risk assessment system according to the invention; P FIG. 3 shows a data structure for a digital trust score according to the invention;

FIG. 4 shows publication of vendor security risk assessment according to the invention;

FIG. 5 shows member verticals according to the invention;

FIG. 6 shows vendor categories according to the invention;

FIG. 7 shows a first page of a vendor security risk assessment final report according to the invention;

FIG. 8 shows a second page of a vendor security risk assessment final report according to the invention;

FIG. 9 shows a risk treatment according to the invention;

FIG. 10 shows a digital trust ecosystem according to the invention; and

FIG. 11 shows a diagrammatic representation of a machine in the example form of a computer system within which a set of instructions for causing the machine to perform one or more of the methodologies discussed herein may be executed.

### DETAILED DESCRIPTION

Embodiments of the invention provide organizations with an efficient method to evaluate the inherent cybersecurity risk to make informed decisions about partnering, acquiring, or doing business with other organizations. For purposes of the discussion herein, the terms “Cybersecurity,” “Information Security,” and “Security” are used interchangeably.

### Vendor Security Risk Assessment

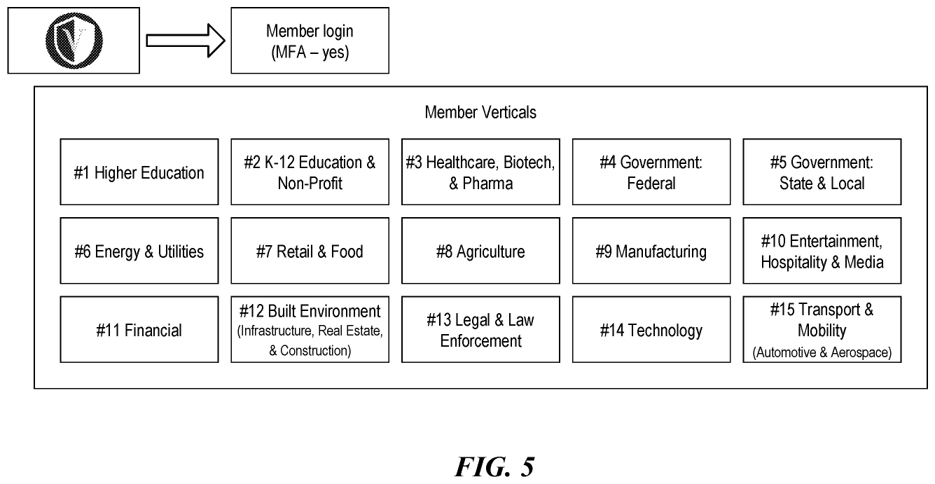

Embodiments of the invention provide vendor security risk assessment to the members of professional associations to improve organizational efficiency. Categories of such vendors can include, for example, the categories shown on FIG. 5.

Embodiments of the invention provide the professional association's membership expertise through, for example validated questionnaires, expert vendor security risk assessment, and education on vendor risk management.

Embodiments of the invention improve organizational insurability by providing cybersecurity risk assessments for the members of professional associations to improve organizational insurability. Applicability of the invention includes, for example higher education, K-12, and state and local government.

Embodiments of the invention improve organizational cybersecurity posture to reduce premiums and/or avoid un-insurability. Security risk assessment includes administering validated cybersecurity insurance questionnaires, performing expert cybersecurity risk assessment, and providing education on cybersecurity risk management.

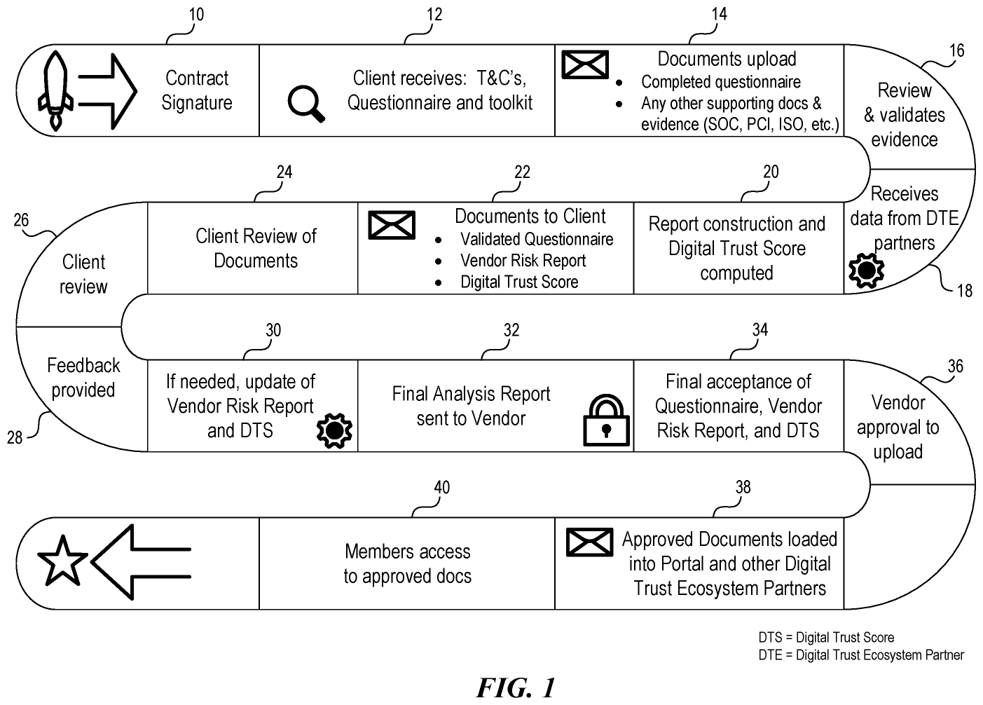

FIG. 1 shows a Vendor Security Risk Assessment system according to the invention. Those skilled in the art will appreciate that the Vendor Security Risk Assessment system may be implemented as a system and/or as a method.

A client signs a contract 10 for a digital risk assessment and receives a questionnaire and toolkit 12. The client uploads the completed questionnaire and any other documents to the digital risk assessment system 14. The documents are reviewed and validated 16, and information is received from digital trust ecosystem partners 18. A report is prepared and a digital trust score is computed 20 and the validated questionnaire, vendor risk report, and digital trust score are sent to the client for review 22. A joint review is performed 26 with the client and feedback 28 is provided which may result in modification of the vendor risk report and digital trust score 30. A final report is then sent to the vendor 32. The vendor provides acceptance of the questionnaire, vendor risk report, and digital trust score 34 and approves publication 36. The approved documents are loaded into the security risk assessment service portal and provided to other digital trust ecosystem partners 38 and then third party member access is provided to the approved documents 40.

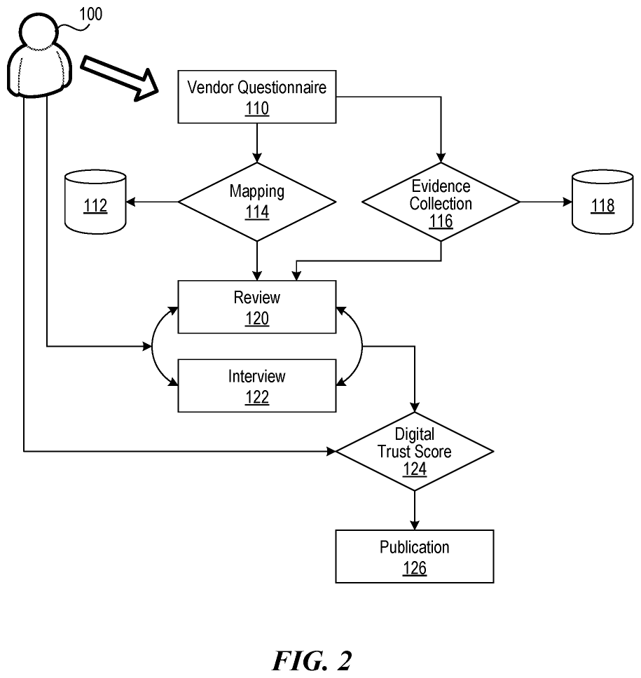

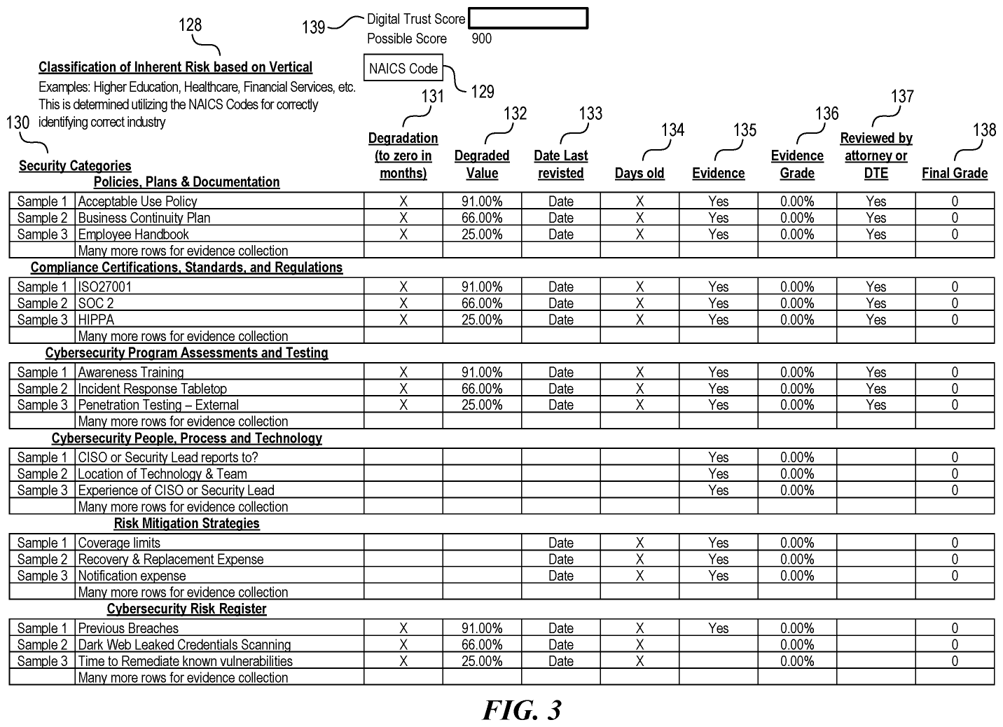

FIG. 2 shows the creation of a digital trust score in a Vendor Security Risk Assessment system according to the invention.

In FIG. 2, a vendor 100 completes a questionnaire 110. The questionnaire may include such questions as, for example:
How long have they been in business?
How many employees do they have?
How experienced is the information security team?
Which Industries do they work in?
Do they do work internationally?

The system performs a vendor questionnaire mapping 114 to one or more security questionnaire data sources 112 that are used to validate and format the questionnaire content. The questionnaire fields and content are parsed and converted to the data source format to perform the mapping. The data sources can comprise any or all of:
a. HECVAT (Higher Education Community Vendor Assessment Tool) is a questionnaire framework specifically designed for higher education to measure vendor risk:
   HECVAT
   HECVAT Lite
   On-premises
b. Privacy:
   GDPR (General Data Protection Regulation) (EU) is a regulation in EU law on data protection and privacy in the European Union (EU) and the European Economic Area (EEA).
   CCPA (California Consumer Privacy Act of 2018) gives consumers more control over the personal information that businesses collect about them.
   HIPAA (Health Insurance Portability and Accountability Act of 1996) is a federal law that requires the creation of national standards to protect sensitive patient health information from being disclosed without the patient's consent or knowledge.
c. CAIQ (Cloud Security Alliance—Consensus Assessment Initiative Questionnaire) which includes 133 control objectives and 16 domains. CAIQ is an industry-accepted way to document what security controls exist in IaaS, PaaS, and Saas services, providing security control transparency. It provides a set of Yes/No questions a cloud consumer and cloud auditor may wish to ask of a cloud provider to ascertain their compliance to the Cloud Controls Matrix (CCM). Therefore, it helps cloud customers to gauge the security posture of prospective cloud service providers and determine if their cloud services are suitably secure.
d. SIG (Standardized Information Gathering Questionnaire—Shared Assessment Group) which includes eighteen risk domains. SIG is a repository of third-party information security and privacy questions, indexed to multiple regulations and control frameworks. SIG is published by a non-profit called Shared Assessments:
   SIG Questionnaire
   SIG Lite
   SIG Core
e. NIST 800-171 (FISMA, CMMC, NERC CIP, FedRAMP) which includes fourteen security objectives. NIST provides recommended requirements for protecting the confidentiality of controlled unclassified information (CUI).
f. PCI DSS (Payment Card Industry) which includes twelve risk Domains. PCI DSS is a global information security standard designed to prevent fraud through increased control of credit card data.

The system also performs evidence collection 116 to gather supporting documentation from various data sources 118. Evidence collection is based upon available and cited resources, e.g. as disclosed in the questionnaire. Evidence collected can include any or all of, for example but not limitation:
SOC2 Type 2 Report
ISO certifications (27001, 9001, 27017, 22301, etc.)
Employee Handbook
Acceptable Use Policy
Access Control Standard
Communications Security Standard
Data Destruction Standard
Encryption Standard
Incident Response Plan
Information Classification Standard
Information Security Policy
Mobile Device Policy
Operations Security Standard
Personnel Security Standard
Physical Environmental Standard
Secure Coding Requirements
Secure Software Development Standard
Security Risk Standard
Third-Party Security Standard
Vulnerability Management Standard

The system processes the data and reviews the results of the questionnaire mapping and evidence collection 120.

An interview is held 122 with the vendor to close any potential gaps that are already identified by the system. This accomplishes a form of supervised machine learning for the system.

The system then builds a draft vendor risk report depicting the digital trust score 124. The digital trust score is derived from a complex algorithm in which data structures are created by combining data from multiple disparate data sources, such as from the questionnaire, mapping, and evidence, where the data structures are evaluated and regularly re-evaluated in near real time.

The following factors affect determination of the digital trust score:
The digital trust score is an intricate look into public facing information and internal cybersecurity team, technology and practices.
The digital trust score is dependent on the industry of the organization.
The digital trust score automatically degrades over time with lack of attention towards cybersecurity hygiene.
The digital trust score validates and weighs the source of document or services, such as the legal team, a digital trust ecosystem partner (discussed below), or an internal resource.

Digital trust score components include independent and ongoing evaluation of items in the following categories:
Cybersecurity People, Process, and Technology;
Policies, Plans, and Documentation;
Compliance, Certifications, Standards, and Regulations;
Cybersecurity Program Assessments and Testing;
Cybersecurity Risk Mitigation Strategies; and
Cybersecurity Risk Register.

These items are regularly polled and processed, e.g. by machine generated queries, into a common format to build and maintain the corresponding data structures.

The vendor then provides a Vendor Security Risk Assessment response to verify the accuracy of the vendor risk report.

Thereafter, a final report is published 126 with the digital trust score.

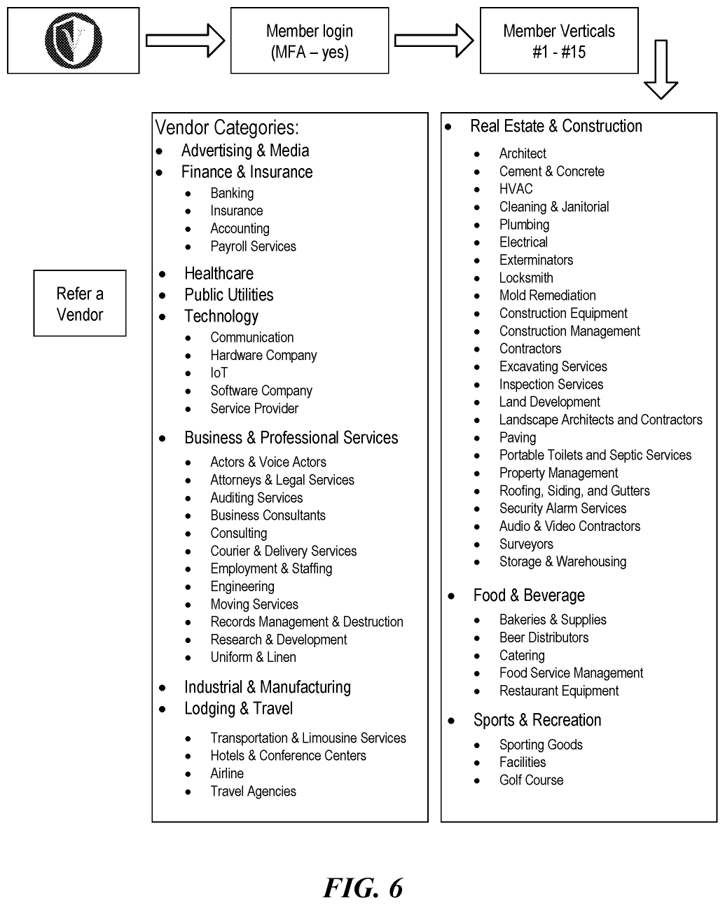

FIG. 3 shows a data structure for a digital trust score according to the invention. In FIG. 3, there is a classification of inherent risk 128 based on the industry vertical (see FIG. 5), e.g. based on the NAICS code 129. The digital trust score components are organized into categories 130 (see FIG. 6), as discussed above. The data structure comprises a matrix of the categories, arranged in rows in FIG. 3 and rules arranged in columns in FIG. 3 that include, for example, degradation intervals 131 and degradation values 132 which establish weights for those items within a security category. The algorithm tracks the date 133 at which each item was visited, the age of the item 134, whether the item is evidence 135, the evidence grade for evidence 136, and whether the item was reviewed by an attorney or a member of the digital trust ecosystem 137. A final grade 138 is calculated for each item based on weightings of the various rules, and the grades for all categories are combined to generate the digital trust score 139. Those skilled in the art will appreciate that other factors may be used to evaluate categories and items within categories when determining the digital trust score. As well, other categories and items may be used as appropriate. The matrix represented by the data structure receives multidimensional time varying data and applies rules in real time to the data to generate the digital trust score. The cybersecurity risk assessment system generates a graphic display of the digital trust score.

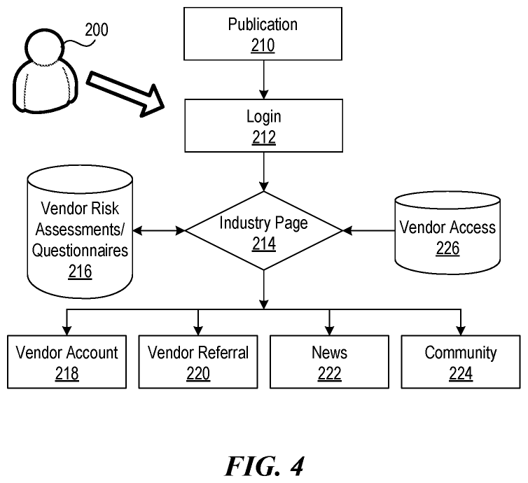

FIG. 4 shows publication of Vendor Security Risk Assessment according to the invention.

A document and questionnaire are to be published on a Website that is accessible to the vendor 200 via a user portal 210. The portal provides management of users. It also provides the vendor with sales leads/notifications of downloads.

From the user login page 212, the user login takes the vendor to their specific industry page 214 (also, see FIG. 5—Member Categories). In embodiments of the invention, the following industries are identified, although other industries may be included as desired:
Healthcare, Biotech, and Pharma
Education and Non-Profit
Financial
Legal and Law Enforcement
Technology
Energy and Utilities
Retail and Food
Government
Manufacturing
Entertainment, Hospitality, and Media

In embodiments, the vendor's industry home page has several main purposes, including any of:
Referring a Vendor 220 (see FIG. 6);
Repository of Vendor Security Risk Assessments and Questionnaires 216;
New and newsworthy 222;
Community for members to provide vendor experiences and customer rating, i.e. Amazon 224; and
Vendor access to their company information for immediate feedback or other possible information, which may be with a vendor subscription 226.

Within each Industry there are searchable and sorted Vendor Security Risk Assessments. The vendor categories can be arranged as shown in FIG. 6.

FIG. 5 shows member verticals that are accessible after member login according to the invention. Those skilled in the art will appreciate that other verticals may be included as desired.

FIG. 6 shows vendor categories that are accessible after member login and selection of a member vertical (FIG. 5) according to the invention. Those skilled in the art will appreciate that other categories may be included as desired.

### Website Look

The member login is industry specific. There are several different Industries.
All member logins look the same, except for the industry depicted on the top of the portal page.
A welcome screen provides a ‘New vendors and industry news’ section, and links to the repository and ‘request a vendor’ form, as well as a ‘search repository’ for easy and fast access to a certain vendor.
The repository categorizes vendors.
A ‘Refer a Vendor’ form can be tracked or imported directly into, for example, Salesforce.
Members can create comments and ratings attached to the vendors.
If a member downloads a Vendor Security Risk Assessment report or completed questionnaire, the vendor receives an email notification.

### Vendor Security Risk Assessment Application

A vendor specific questionnaire link is sent to vendors to complete their company's vendor questionnaire.
The application allows a vendor to complete the vendor questionnaire.
The application takes the responses from the questionnaire and auto-completes industry specific vendor questionnaires. A proprietary platform can create the questions and map the questions to industry specific vendor questionnaires.

### Vendor Login

Allows vendors (if they subscribe) to login and comment on member's comments.
Allows vendors to upload new evidence that can impact their digital trust score. For example, a penetration test was just completed.

### Vendor Security Risk Assessment Application and Digital Trust Score

Standardized on a self-generating report and a digital trust score from the questionnaire and evidence gathering.

### Vendor Risk Management

Allows members to import their vendors into their profile to manage their vendors, e.g. via a check off box that moves the vendor to their profile.
Allows members to identify their vendor as a ‘High’, ‘Moderate’, or Low Risk’ vendor.
Creates a ‘1-click’ Vendor Security Risk Assessment report on their current vendors.

### Vendor Security Risk Assessment Report

When a vendor completes a questionnaire the input information is populated to all industries. However, the system parses the input information to automatically populate vendor answers selectively to appropriate industries. A user is directed to an appropriate industry based on a user login profile.

Cybersecurity risk assessment is performed in near real time based upon real time vendor inputs and regular vendor updates, as well as updates provided by ecosystem participants and evidentiary updates. See FIGS. 2 and 3.

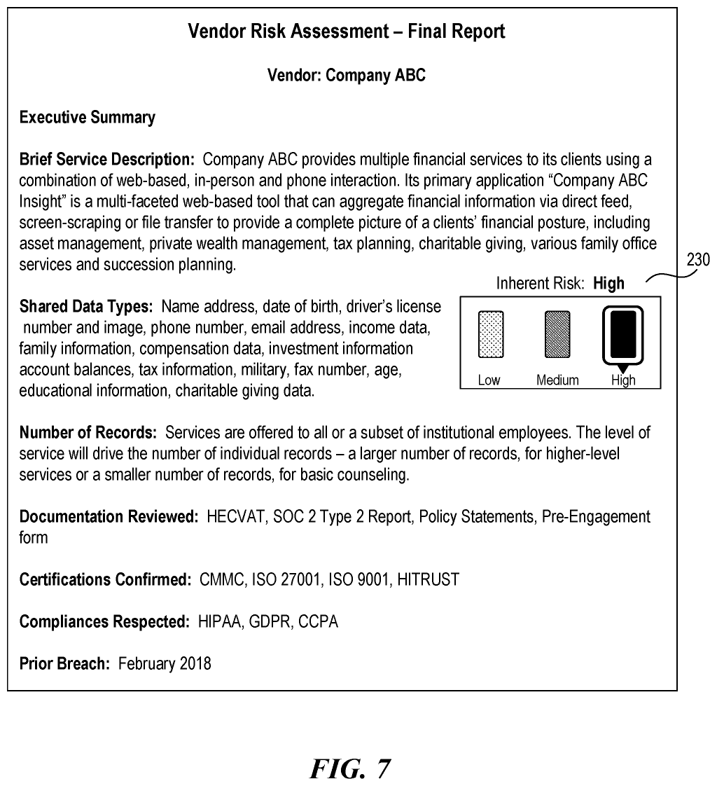

FIG. 7 shows a first page of a Vendor Security Risk Assessment—Final Report according to the invention. The report is generated automatically and includes a digital trust score 230, shown on FIG. 7 as Inherent Risk, which establishes a threshold for vendor approval and/or review. The digital trust score is algorithmically generated based on vendor questionnaire mapping and evidence collection, as described above in connection with FIGS. 2 and 3.

In FIG. 7 the digital trust score is shown by highlighting one of three indicators, Low, Medium, High. In FIG. 7, the risk is shown as High. Significantly, the digital trust score (Inherent Risk in FIG. 7) is machine generated. The digital trust score predicts future risk, e.g. High, as a result of machine learning based on algorithmic analysis and mapping of disparate data sources in near real time and based on application of rules, as discussed above in connection with FIGS. 2 and 3. Those skilled in the art will appreciate that the digital trust score may be generated for presentation to a user as any desired graphic representation.

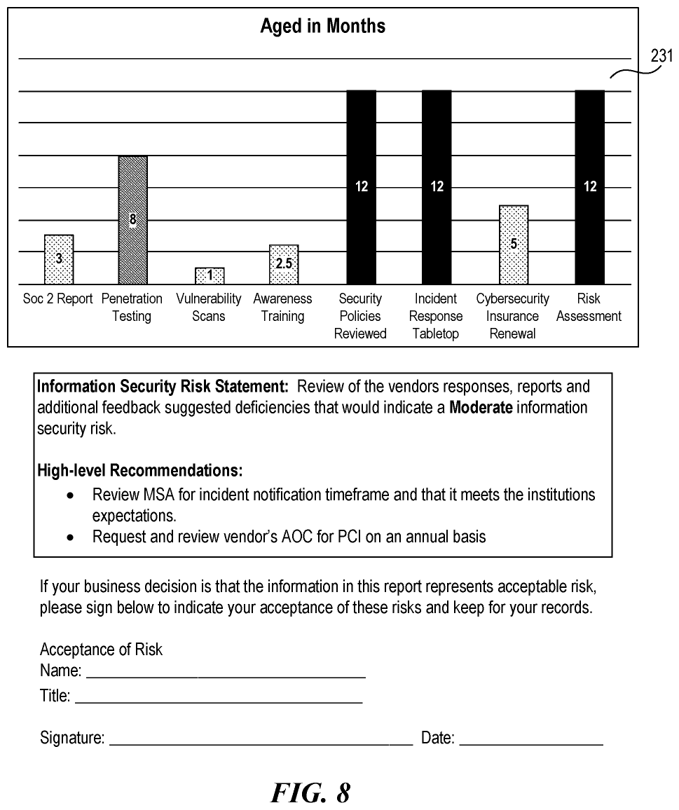

FIG. 8 shows a second page of a Vendor Security Risk Assessment—Final Report according to the invention. Vendor data is shown in a graph 231 with risk factors considered aged in months. The system provides regularly spaced intervals for vendor update of information within the report. The values displayed in the graph are generated from the data structure discussed above but sort the data along multiple dimensions to show risk at a higher degree of granularity, e.g. AWARENESS TRAINING which was reviewed recently, i.e. 2.5 months ago, has a relatively low risk, while SECURITY POLICIES REVIEWED which was not reviewed recently, i.e. 12 months ago, has a relatively high risk. Thus, embodiments of the invention perform security risk assessment overall, as discussed above in connection with the digital trust score, and also perform security risk assessment based on underlying data within the data structure such as aging of security tasks, etc.

### Detailed Report

A detailed report follows the first pages of the report which provide a summary. The detailed report provides information on such occurrence as a security breach and resolution thereof.

A typical detailed report may be in the following format:

### Mission Statement

Company ABC's mission is . . . .

### Service Description

Company ABC, a Limited Liability Corporation, is headquartered in Delaware. Created in 2010, Company ABC now has approximately 250 employees in 5 locations throughout the United States. They currently have five on their IT team with one person solely committed to Information Security.

Company ABC has 5 applications that fall under the company's Information Security Policies. Those Applications are hosted in Microsoft Azure, and are:
1. A
2. B
3. C
4. D
5. E

### Assessment Findings

The HECVAT and SOC 2 attestation were reviewed during the week of Jun. 10, 2022. No concerns were found in either report.

Both internal and external Vulnerability Testing is conducted monthly.

Penetration Testing was conducted from an external perspective only. The internal network, website, and web applications have not been tested since . . . .

Onboarding and offboarding employees . . . .

### Compliance & Certifications

Company ABC has invested in their cybersecurity department. They currently abide to GDPR standardization, ISO 9001 (2008, Quality Management), ISO 27001 (2021, Information Security), ISO 27701 (2022, Privacy), and ISO 22301 (2022, Business Continuity)

### Prior Breach Summary and Remediation

Company ABC experienced a breach in February of 2019. Their breach was from an unpatched vulnerability in their standard OS configuration. The impact of the breach was confined to a hundred records that contained no personal information. Since the breach, Company ABC conducts monthly vulnerability scans of their internal and external networks.

### Assessment Considerations

The use of service providers may expose organizations to risks that can result in regulatory action, financial loss, litigation, and loss of reputation.

This Vendor Security Risk Assessment is based on security controls requirements and industry best practices. It is intended to identify potential information security risks arising from the use of service providers and to support the organization's risk prioritization, mitigation, and management strategies as part of the overall organizational Enterprise Risk Management process.

Each organization must make its own determination as to the acceptability of the risk associated with providing data to any third-party. Risks should be reviewed and discussed as the organization continues to proceed with the vendor.

### Additional Vendor Management Recommendations for Consideration

Ensure contracts are in place and address security provisions and requirements.
Ensure service implementation meets the organizations security and control requirements.
Establish processes to ensure that vendors are reviewed when services change and on a periodic basis, based on risk.

### The Following Documentation as Reviewed as Part of the Assessment

Company ABC's completed HECVAT questionnaire
Company ABC's SOC2 Type 2 Report, signed Mar. 10, 2022, for the period Mar. 1, 2022-Feb. 28, 2023
Company ABC's Consensus Assessment Initiative Questionnaire (CAIQ)
Company ABC's Acceptable Use Policy
Company ABC's Access Control Standard
Company ABC's Communications Security Standard
Company ABC's Data Destruction Standard
Company ABC's Encryption Standard
Company ABC's Incident Response Plan
Company ABC's Information Classification Standard
Company ABC's Information Security Policy
Company ABC's Mobile Device Policy
Company ABC's Operations Security Standard
Company ABC's Personnel Security Standard
Company ABC's Physical Environmental Standard
Company ABC's Secure Coding Requirements
Company ABC's Secure Software Development Standard
Company ABC's Security Risk Standard
Company ABC's Third-Party Security Standard
Company ABC's Vulnerability Management Standard

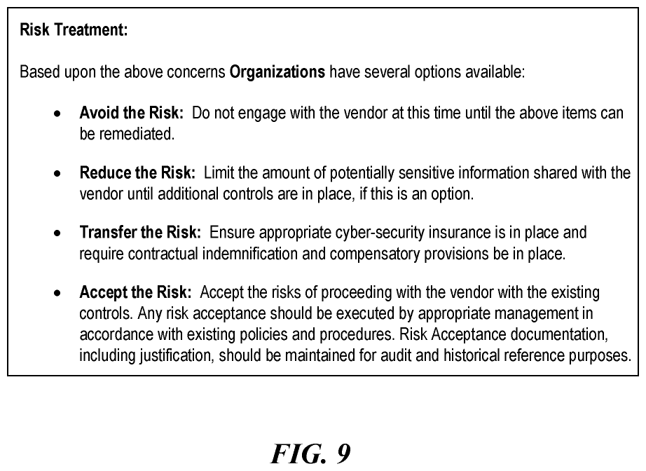

FIG. 9 shows a risk treatment according to the invention. The risk treatment is algorithmically generated based on processing of the time varying, multidimensional data structure and provides recommendations for addressing risks outlined in the Vendor Security Risk Assessment.

### Digital Trust Ecosystem

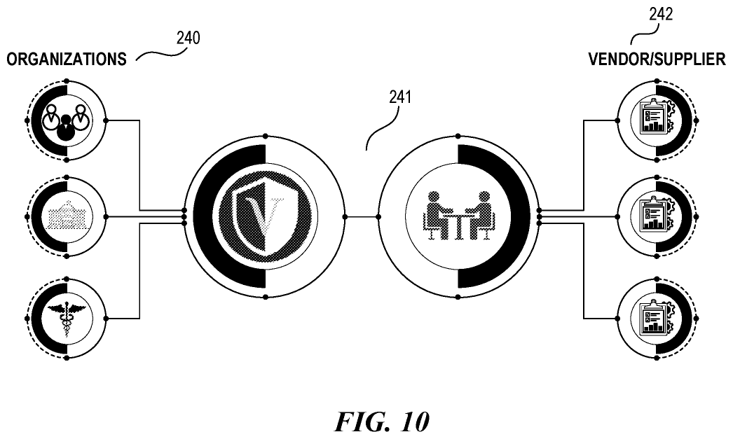

FIG. 10 shows a digital trust ecosystem according to the invention. The digital trust ecosystem includes a cybersecurity risk assessment service 241 responsible for determining a digital trust score based on interaction with vendors/suppliers 242, as discussed above. The digital trust ecosystem partners are organizations 240, i.e. law firms, cybersecurity firms, insurance companies, tech companies, etc. that can report cybersecurity related information directly to the security risk assessment service on behalf of their clients. This information is used by the security risk assessment service as inputs when generating the digital trust score and vendor security risk assessment.

### Computer Implementation

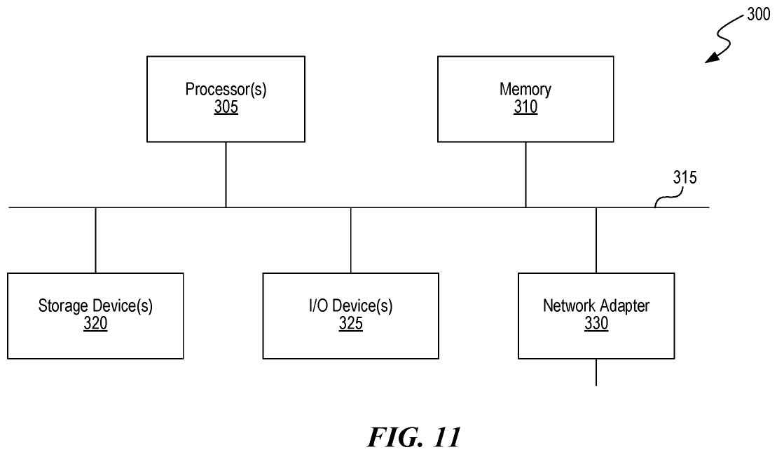

FIG. 11 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 300 may include one or more central processing units (“processors”) 305, memory 310, input/output devices 325, e.g. keyboard and pointing devices, touch devices, display devices, storage devices 320, e.g. disk drives, and network adapters 330, e.g. network interfaces, that are connected to an interconnect 315. The interconnect 315 is illustrated as an abstraction that represents any one or more separate physical buses, point to point connections, or both connected by appropriate bridges, adapters, or controllers. The interconnect 315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 310 and storage devices 320 arc computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 310 can be implemented as software and/or firmware to program the processor 305 to carry out actions described above. In some embodiments, such software or firmware may be initially provided to the processing system 300 by downloading it from a remote system through the computing system 300, e.g. via network adapter 330.

The various embodiments introduced herein can be implemented by, for example, programmable circuitry, e.g. one or more microprocessors, programmed with software and/or firmware, or entirely in special purpose hardwired (non-programmable) circuitry, or in a combination of such forms. Special-purpose hardwired circuitry may be in the form of, for example, one or more ASICs, PLDs, FPGAs, etc.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A computer implemented vendor security risk assessment method, comprising:
a processor creating a digital trust score by:
receiving a completed vendor questionnaire from a vendor;
mapping said a vendor questionnaire to one or more disparate security questionnaire data sources;
collecting evidence to gather supporting documentation from a plurality of disparate, time varying data sources;
processing questionnaire mapping and evidence collection results;
receiving results of a vendor interview to close any potential gaps that are already identified;
generating a draft vendor security risk report including a digital trust score;
receiving a vendor security risk assessment response to verify a accuracy of the vendor risk report;
generating a graphical representation of said digital trust score for display on a display device; and
publishing a final vendor security risk assessment report including said graphical representation of said digital trust score.

2. The method of claim 1, wherein said digital trust score is generated by:
said processor querying public facing information and internal cybersecurity team, technology and practices;
said processor weighting digital trust score generation based on an organization;
said processor automatically degrading said digital trust score over time based on lack of attention towards cybersecurity hygiene; and
said processor validating and weighting sources of document or services, including those of a legal team, a digital trust ecosystem partner, and an internal resource.

3. The method of claim 2, further comprising:
a processor performing independent and ongoing evaluation of any of:
Cybersecurity People, Process, and Technology;
Policies, Plans, and Documentation;
Compliance, Certifications, Standards, and Regulations;
Cybersecurity Program Assessments and Testing;
Cybersecurity Risk Mitigation Strategies; and
Cybersecurity Risk Register.

4. The method of claim 1, further comprising:
providing a user portal for said final vendor security risk assessment report and questionnaire on a website that is accessible to the vendor.

5. The method of claim 1, wherein said one or more security questionnaire data sources comprise any of:
HECVAT (Higher Education Community Vendor Assessment Tool) questionnaire framework specifically designed for higher education to measure vendor risk;
GDPR (General Data Protection Regulation) (EU) regulation in EU law on data protection and privacy in the European Union (EU) and the European Economic Area (EEA);
CCPA (California Consumer Privacy Act of 2018);
HIPAA (Health Insurance Portability and Accountability Act of 1996);
CAIQ (Cloud Security Alliance—Consensus Assessment Initiative Questionnaire);
SIG (Standardized Information Gathering Questionnaire—Shared Assessment Group);
NIST 800-171 (FISMA, CMMC, NERC CIP, FedRAMP); and
PCI DSS (Payment Card Industry).

6. The method of claim 1, wherein evidence collected comprises any of:
SOC2 Type 2 Report;
ISO certifications;
Employee Handbook;
Acceptable Use Policy;
Access Control Standard;
Communications Security Standard;
Data Destruction Standard;
Encryption Standard;
Incident Response Plan;
Information Classification Standard;
Information Security Policy;
Mobile Device Policy;
Operations Security Standard;
Personnel Security Standard;
Physical Environmental Standard;
Secure Coding Requirements;
Secure Software Development Standard;
Security Risk Standard;
Third-Party Security Standard; and
Vulnerability Management Standard.

7. The method of claim 1, further comprising:
providing a vendor's industry home page for any of:
referring a vendor;
repository of Vendor Security Risk Assessments and questionnaires;
new and newsworthy; and
community for members to provide vendor experiences and customer rating.

8. The method of claim 7, further comprising:
providing within each industry searchable and sorted Vendor Security Risk Assessments.

9. The method of claim 1, wherein said digital trust score comprises a threshold for vendor approval and/or review.

10. The method of claim 9, further comprising:
algorithmically generating said digital trust score based on vendor questionnaire mapping and evidence collection.

11. The method of claim 1, further comprising:
displaying risk factors considered aged in months in the Vendor Security Risk Assessment.

12. A computer implemented method for generating a data structure for a digital trust score, comprising:
a processor applying a classification of inherent risk based on an industry vertical; and
the processor organizing digital trust score components into a plurality of categories, each said category comprising a plurality of items;
wherein said data structure comprises a matrix of said items arranged by categories, said items arranged in rows, said matrix comprising rules arranged in columns;
said matrix receiving categorical multidimensional time varying data and applying said rules in near real time to said data to generate said digital trust score; and
said processor generating a graphical representation of said digital trust score for display on a display device.

13. The method of claim 12, further comprising:
said processor applying said rules to said items to generate a final grade for each item based on weightings of said rules.

14. The method of claim 12, wherein said rules comprise any of:
degradation intervals;
degradation values which establish weights for items within a category;
a date at which each item was visited;
age of the item;
whether the item is evidence;
an evidence grade for evidence; and
whether the item was reviewed by an attorney or a member of the digital trust ecosystem.

15. The method of claim 13, further comprising:
said processor combining grades for all item in all categories to generate said digital trust score.

16. The method of claim 12, further comprising:
said processor further configured to sort data within said data structure along multiple dimensions to show risk for selected items and/or categories at a selected degrees of granularity.

17. A digital trust ecosystem, comprising:
a processor configured for implementing a security risk assessment service, said security risk assessment service:
determining a digital trust score based on interaction with vendors/suppliers;
receiving cybersecurity related information directly from a plurality of partner organizations, said partner organizations reporting to said security risk assessment service on behalf of their clients, said cybersecurity related information comprising an input to said security risk assessment service;
generating said digital trust score and/or a vendor security risk assessment by:
applying a classification of inherent risk based on an industry vertical;
organizing a plurality of digital trust score components into a plurality of categories, each said category comprising a plurality of items;
generating a data structure comprising a matrix of said items arranged by categories, said items arranged in rows, said matrix comprising rules arranged in columns; and
said matrix receiving categorical multidimensional time varying data and applying said rules in near real time to said data to generate said digital trust score for display on a display device.

18. The digital trust ecosystem of claim 17, said processor further configured to sort data within said data structure along multiple dimensions to show risk for selected items and/or categories at a selected degrees of granularity.

19. The digital trust ecosystem of claim 17, wherein said vendor security risk assessment comprises risk factors considered aged in months.
